(19) United States
(12) Patent Application Publication
(10) Pub. No.: US 2016/0230355 A1
(43) Pub. Date: Aug. 11, 2016

(54) PUSH-ROLLER ASSEMBLY FOR PAVING MACHINE

(71) Applicant: Caterpillar Paving Products Inc., Brooklyn Park, MN (US)

(72) Inventor: Ryan J. Nelson, Maple Grove, MN (US)

(73) Assignee: Caterpillar Paving Products Inc., Brooklyn Park, MN (US)

(21) Appl. No.: 15/132,659

(22) Filed: Apr. 19, 2016

(51) Int. Cl. E01C 19/48; B60R 19/16

(52) U.S. Cl. CPC E01C 19/48; B60R 19/16; E01C 2301/08

(57) ABSTRACT

A paving machine is provided. The paving machine includes a frame having an engaging portion. The push-roller assembly includes a push-roller support frame coupled with the engaging portion. The push-roller support frame is movable along a longitudinal axis of the paving machine. The push-roller support frame includes a supporting portion and a flange portion. The push-roller support assembly includes a pin member engagable to the flange portion and partially received within a slot of the engaging portion, The pin member is movable between a plurality of positions within a recess. The push-roller assembly includes at least one roller coupled with the flange portion. The at least one roller is adapted to move within the recess along with the pin member. The push-roller assembly also includes an actuator disposed on the frame of the paving machine. The actuator is adapted to selectively move the pin member within the recess.

### TECHNICAL FIELD

The present disclosure relates to a paving machine and more particularly, to a push-roller assembly for the paving machine.

### BACKGROUND

Machines, such as a paving machine, are used for applying paying material on a surface, such as a roadway, during a paving operation. The paving machine includes a receptacle that receives the paving material, typically from a truck. For supplying the paving material into the receptacle of the paving machine, the truck backs up towards the paving machine such that a bed of truck can be tilted for unloading the paving material into the receptacle of the paving machine. The paving machine includes a push-roller provided at an end of the receptacle for aligning the truck with respect to the paving machine. When the truck is aligned, a pair of ground engaging members of the truck abuts the push-roller of the paving machine, thereby ensuring proper alignment of the truck with respect to the paving machine. However, trucks with different dimensions and sizes may be used for delivering the paving material to the paving machine. Based on size and dimension of the truck, the push-roller is adjusted to different positions for ensuring proper alignment of the truck with respect to the paving machine. Moreover, existing push-rollers require manual labor and tools for adjustment, based on the dimension and the size of the paving machine. Such manual adjustment of the push-roller would lead to inconvenience, usability reduction, and time wastage.

J.P Patent Application Number 2006/161399, hereinafter referred to as '399 application, discloses a push roller device of a paving equipment. The push roller device includes a shock-absorbing device. The shock-absorbing device is provided for cushioning an impact between a dump truck and the paying equipment when a right rear wheel and a left rear wheel of a dump truck abut a pair of push rollers. However, the push roller device of the '399 application may not be adjusted for positioning dump trucks of different sizes and shapes with respect to the paving machine.

### SUMMARY OF THE DISCLOSURE

in one aspect of the present disclosure, a paving machine is provided. The paving machine includes a frame having an engaging portion at a front end of the paving machine. The engaging portion includes a top plate and a bottom plate spaced apart from the top plate. The engaging portion also includes a recess defined between the top plate and the bottom plate. Further, the engaging portion includes a slot formed within at least one of the top plate and the bottom plate. The paying machine also includes a push-roller assembly disposed at the front end of the paving machine. The push-roller assembly includes a push-roller support frame coupled with the engaging portion. The push-roller support frame is adapted to move along a longitudinal axis of the paving machine. The push-roller support frame includes a supporting portion, and a flange portion having a hole. The flange portion is received substantially within the recess. The push-roller support assembly includes a pin member engageable to the flange portion of the push-roller support frame through the hole of the flange portion. The pin member is partially received within the slot of the engaging portion. The pin member is adapted to move between a plurality of positions along the longitudinal axis within the recess. The push-roller assembly includes at least one roller coupled with the flange portion of the push-roller support frame. The at least one roller is adapted to move within the recess along with the pin member during a movement of the push-roller support frame along the longitudinal axis. The push-roller assembly also includes an actuator disposed on the frame of the paving machine. The actuator has a first end coupled with the frame and a second end coupled with the pin member. The push-roller assembly also includes at least one push-roller coupled with the supporting portion of the push-roller support frame. The at least one push-roller is adapted to be engaged with a vehicle. The actuator is adapted to selectively move the pin member within the recess. Further, the movement of the actuator causes the pin member and the at least one roller to displace the push-roller support frame with respect to the frame along the longitudinal axis.

Other lead aspects of this disclosure will be apparent from the following description and the accompanying drawings.

### BRIEF DESCRIPTION OF THE DRAWINGS

FIG. 1 is a diagrammatic view of a paving machine having a push-roller assembly, according to one embodiment of the present disclosure, and a vehicle positioned adjacent to the paving machine during a material transfer process;

FIG. 2 is a perspective view of the push-roller assembly supported on a frame of the paving machine of FIG. 1;

FIG. 3 is a top view of the push-roller assembly of FIG. 2 supported on the frame of the paving machine;

FIG. 4 is a partial side sectional view of the frame with the push-roller assembly at a first position thereof;

FIG. 5 is a partial side sectional view of the frame with the push-roller assembly at a second position thereof; and

FIG. 6 is a partial side sectional view of the frame of the paving machine having a push-roller assembly, according to another embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

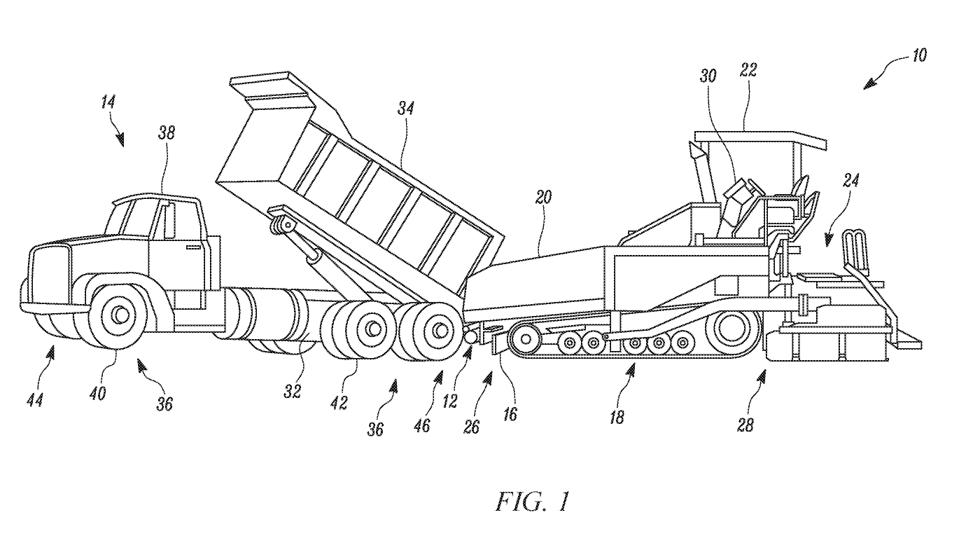

FIG. 1 illustrates a side view of a paving machine 10. The paving machine 10 is embodied as a wheel-type paving machine. However, the paving machine 10 may be a track-type paving machine. The paving machine 10 may be used in various applications to apply a material, such as asphalt, on a work surface. The paving machine 10 includes a frame 16 that supports various components including, but not limited to, a receptacle 20, an operator station 22, and a screed assembly 24. The receptacle 20 is disposed adjacent to a front end 26 of the paving machine 10. The receptacle 20 is adapted to contain the material to be applied on the work surface. The operator station 22 is disposed adjacent to a rear end 28 of the paving machine 10. The operator station 22 includes a control console 30 used by a machine operator to control various operations, such as a paving operation of the paving machine 10. The control console 30 may include, but is not limited to, push buttons, electronic switches, toggle switches, and display units. Further, the screed assembly 24 is disposed at the rear end 28 of the paving machine 10. The screed assembly 24 receives the material from the receptacle 20 and deposit the material on the work surface. The paving machine 10 also includes a pair of track assemblies 18 disposed on each side of the paving machine 10 for propelling the paving machine 10.

Referring to FIG. 1, a vehicle 14 is shown at the front end 26 of the paving machine 10. The vehicle 14 is embodied as a dump truck. However, the vehicle 14 may also include, but is not limited to, a haul truck, an articulated truck, an off-highway truck or any other machine that is adapted to transport the material to a desired location. The vehicle 14 includes a frame 32 for supporting various components of the vehicle 14, a bed 34 for loading, carrying, and unloading the material at the desired location, a set of ground engaging members 36 for propelling the vehicle 14, and an operator cabin 38 for accommodating an operator. The bed 34 is pivotally connected to the frame 32 of the vehicle 14 and contains material for transferring to the desired location. The bed 34 may be operated by one or more control levers not shown) disposed in the operator cabin 38 of the vehicle 14.

The set of ground engaging members 36 includes a front set of ground engaging members 40 and a rear set of ground engaging members 42. The front net of ground engaging members 42 is disposed adjacent to a front end 44 of the vehicle 14. The rear set of ground engaging members 42 is disposed adjacent to a rear end 46 of the vehicle 14. The front and rear sets of ground engaging members 40, 42 are wheels. However, in various examples, the front and rear sets of ground engaging members 40, 42 may be track assemblies.

Referring to FIG. 1, the paving machine 10 further includes a push-roller assembly 12 disposed at the front end 26 of the paving machine 10. The push-roller assembly 12 is coupled with the frame 16 of the paving machine 10. The push-roller assembly 12 is adapted to abut the set of ground engaging members 36 of the vehicle 14 during a paving operation. More specifically, the push-roller assembly 12 of the paving machine 10 abuts the rear set of ground engaging members 42 of the vehicle 14 during the paving operation. The push-roller assembly 12 provides a smooth engagement of the vehicle 14 with the paving machine 10 during the paving operation.

During the paving operation, the vehicle 14 is positioned adjacent to the front end 26 of the paving machine 10 such that the bed 34 is positioned adjacent to the receptacle 20. This requires the vehicle 14 to back up to the paving machine 10 until the rear set of ground engaging members 42 of the vehicle 14 abuts the push-roller assembly 12. Thereafter, the bed 34 may be raised to unload the material in the receptacle 20 of the paving machine 10. The material is deposited in the receptacle 20 gradually as the paving machine 10 moves, while pushing the vehicle 14, along the work surface to be paved.

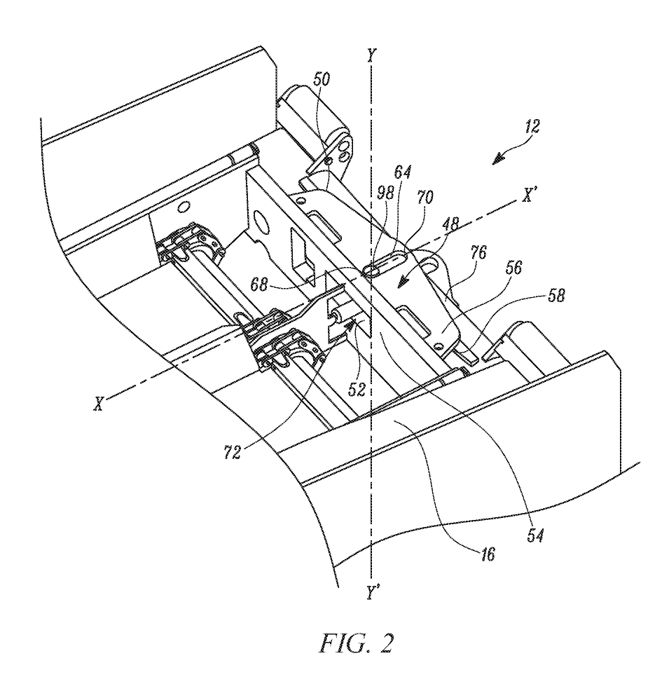

Furthermore, in order to obtain proper alignment and positioning of the vehicle 14 and the bed 34 relative to the receptacle 20 of the paving machine 10, the push-roller assembly 12 is positioned with respect to the frame 16 of the paving machine 10 and the vehicle 14. A predefined distance between the paving machine 10 and the vehicle 14 is desired based on a size and configuration of the vehicle 14 in order to align and position the vehicle 14 relative to the receptacle 20 of the paving machine 10. Therefore, the push-roller assembly 12 is adjustable in order to obtain the predefined distance between the paving machine 10 and the vehicle 14. In one example, the push-roller assembly 12 is adjusted based on a user input from the control console 30. In another example, the push-roller assembly 12 may be adjusted based on inputs from a controller (not shown) of the paving machine 10. In such a case, the controller determines the predefined distance between the paving machine 10 and the vehicle 14. The construction and working of the push-roller assembly 12 are explained in detail with reference to FIGS. 2 to 4.

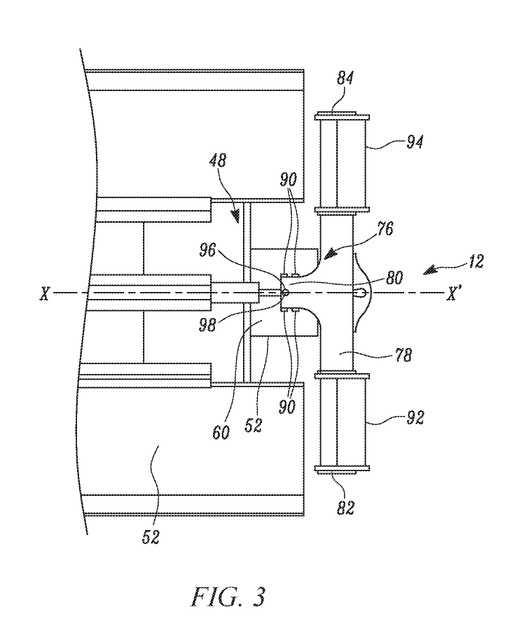

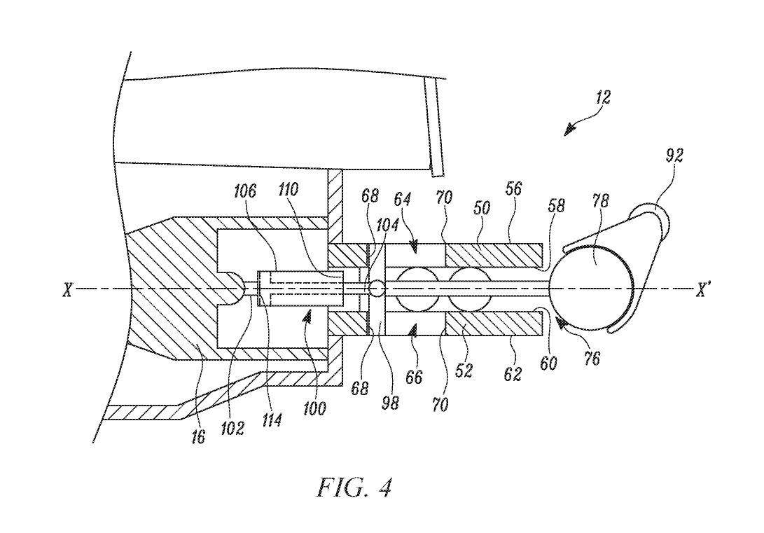

FIG. 2 is a perspective view of the push-roller assembly 12 supported on the frame 16 of the paving machine 10. The frame 16 includes an engaging portion 48 positioned at the front end 26 of the paving machine 10. The engaging portion 48 includes atop plate 50, a bottom plate 52 spaced apart from the top plate 50, and a side plate 54 extending between the top plate 50 and the bottom plate 52. The top plate 50 includes a first top surface 56 and a first bottom surface 58. The bottom plate 52 includes a second top surface 60 (shown in FIG. 3) and a second bottom surface 62 (shown in FIG. 4).

The bottom plate 52 is spaced apart from the top plate 50 along a vertical axis YY′ of the paving machine 10. The top and bottom plates 50, 52 are attached to the side plate 54 in such a manner that the first bottom surface 58 of the top plate 50 faces the second top surface 60 of the bottom plate 52. The top plate 50 includes a first slot 64 extending along a longitudinal axis XX′ perpendicular to the vertical axis YY′ of the paving machine 10. Similarly, the bottom plate 52 includes a second slot 66 (shown in FIG. 4) extending along the longitudinal axis XX′. Each of the first and second slots 64, 66 includes a first end 68 and a second end 70. The engaging portion 48 also includes a recess 72. The recess 72 is defined between the top plate 50 and the bottom plate 52 of the engaging portion 48.

The push-roller assembly 12 includes a push-roller support frame 76 coupled with the engaging portion 48 of the frame 16. In particular, the push-roller support frame 76 is supported within the recess 72 of the engaging portion 48. The push-roller support frame 76 is movable within the recess 72 along the longitudinal axis XX′.

FIG. 3 is a top view of the push-roller assembly 12 supported on the frame 16 with one or more components removed. The push-roller support frame 76 includes a supporting portion 78 and a flange portion 80. The flange portion 80 of the push-roller support frame 76 is received substantially within the recess 72 (see FIG. 2) of the engaging portion 48. The flange portion 80 defines a hole 96.

The supporting portion 78 has an elongated cylindrical body. The supporting portion 78 has a first supporting end 82 and a second supporting end 84 distal to the first supporting end 82. The supporting portion 78 supports a first push-roller 92 at the first supporting end 82. The supporting portion 78 also supports a second push-roller 94 at the second supporting end 84. In one example, the first push-roller 92 and the second push-roller 94 are rotatably supported at the first and second supporting ends 82. 84, respectively. The first and second push-rollers 92, 94 are adapted to be engaged with the rear set of ground engaging members 42 (see FIG. 1) of the vehicle 14 during the paving operation. In one example, the first and second push-rollers 92, 94 may include outer surfaces adapted to rotatably engage with the rear set of ground engaging members 42.

The push-roller assembly 12 also includes four rollers 90 coupled with the flange portion 80 of the push-roller support frame 76. The rollers 90 facilitate movement of the push-roller support frame 76 within the recess 72. In one example, the rollers 90 may be rotatably coupled with the flange portion 80 of the push-roller support frame 76 by means of shafts and bearings (not shown). The rollers 90 are supported on the bottom plate 52 of the engaging portion 48. The rollers 90 are adapted to move on the bottom plate 52 in order to displace the push-roller support frame 76 within the recess 72 along the longitudinal axis XX′. Referring to FIGS. 2 and 3, the push-roller assembly 12 includes a pin member 98 engagable to the flange portion 80 of the push-roller support frame 76. The pin member 98 is received through the hole 96 of the flange portion 80.

FIG. 4 is a partial side sectional view of the frame 16 showing the push-roller assembly 12 at a first position. The pin member 98 is partially received within the first slot 64 of the top plate 50 and the second slot 66 of the bottom plate 52. At the first position, the pin member 98 is disposed at the first ends 68 of the first and second slots 64, 66. The pin member 98 is movable between a plurality of positions along the longitudinal axis XX′ within the recess 72. The plurality of positions is defined between the first ends 68 and the second ends 70 of the first slot 64 and the second slot 66. More specifically, the pin member 98 is movable to any location between the first ends 68 and the second ends 70. The movement of the pin member 98 along the longitudinal axis XX′ displaces the push-roller support frame 76 with respect to the frame 16 in order to position the first and second push-rollers 92, 94 at the predefined distance.

Further, in order to move the pin member 98 within the first and second slots 64, 66, the push-roller assembly 12 includes an actuator 100, The actuator 100 is adapted to selectively move the pin member 98 between the plurality of positions based on the user input from the control console 30. The actuator 100 has a first end 102 and a second end 104 distal to the first end 102. The first end 102 is coupled with the frame 16 of the paving machine 10 and the second end 104 is coupled with the pin member 98 of the push-roller assembly 12. The actuator 100 is a hydraulic actuator. However, the actuator 100 may be an electric actuator, a screw type actuator, a pneumatic actuator or any other linear actuator known in the art.

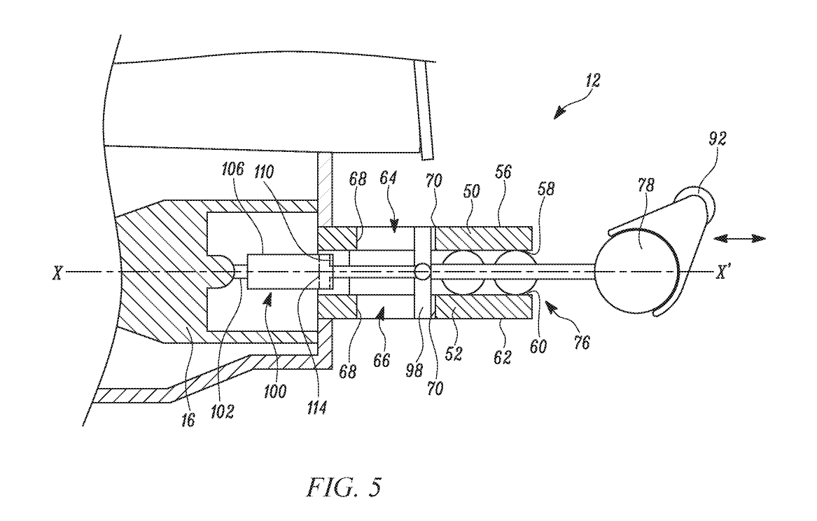

In one example, the actuator 100 includes a cylinder 106 extending between ahead end 108 and a rod end 110. The actuator 100 also includes a plunger 114 slidably received within the cylinder 106 through the rod end 110 of the cylinder 106. The plunger 114 is coupled with the pin member 98 of the push-roller assembly 12. The plunger 114 is movable between a retracted position (shown in FIG. 4) and an extended position (shown in FIG. 5) within the cylinder 106 to selectively move the pin member 98 between the plurality of positions within the recess 72. In the retracted position, the plunger 114 is disposed adjacent to the head end 108 of the cylinder 106. Further, in the extended position, the plunger 114 is disposed adjacent to the rod end 110 of the cylinder 106.

FIG. 5 is a partial side sectional view of the frame 16 showing the push-roller assembly 12 at a second position. At the second position, the pin member 98 is disposed at the second ends 70 of the first and second slots 64, 66. Based on the movement of the plunger 114 to the extended position, the pin member 98 is moved to the second ends 70 of the first and second slots 64, 66. Further, the movement of the pin member 98 causes the rollers 90 to displace the push-roller support frame 76 with respect to the frame 16 along the longitudinal axis XX′. For explanation purposes, the pin member 98 is shown to move between the first ends 68 and the second ends 70 of the first and second slots 64, 66, however, it is contemplated that the pin member 98 may be moved between any intermediate positions defined between the first and second ends 68, 70 based on the user input.

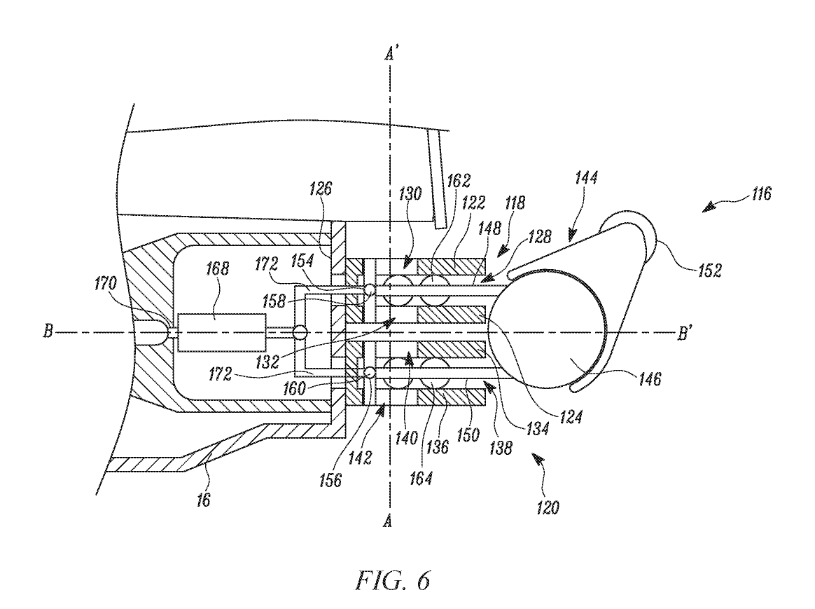

FIG. 6 is a partial side sectional view of the frame 16 of the paving machine 10 having a push-roller assembly 116, according to another embodiment of the present disclosure. The frame 16 includes a first engaging portion 118 and a second engaging portion 120. The first engaging portion 118 is spaced apart from the second engaging portion 120 along a vertical axis AA′ of the paving machine 10. The first engaging portion 118 includes a first top plate 122, a first bottom plate 124, and aside plate 126. The first top plate 122, the first bottom plate 124, and the side plate 126 together define a first recess 128 therebetween. Further, the first engaging portion 118 includes a first slot 130 defined in the first top plate 122, and a second slot 132 defined in the first bottom plate 124. Similarly, the second engaging portion 120 includes a second top plate 134 and a second bottom plate 136. The second top plate 134 and the second bottom plate 136 are attached to the side plate 126. The second top plate 134, the second bottom plate 136, and the side plate 126 together define a second recess 138 therebetween. The second top plate 134 defines a third slot 140 and the second bottom plate 136 defines a fourth slot 142.

The push-roller assembly 116 is disposed at the front end 26 of the paving machine 10. The push-roller assembly 116 includes a push-roller support frame 144. The push-roller support frame 144 is engaged with both the first and second engaging portions 118, 120. The push-roller support frame 144 is movable along a longitudinal axis BB′ perpendicular to the vertical axis AA′ of the paving machine 10. The push-roller support frame 144 includes a supporting portion 146, a first flange portion 148, and the second flange portion 150. The supporting portion 146 supports a first push-roller 152 and a second push-roller (not shown). The first push-roller 152 and the second push-roller are adapted to be engaged with the rear set of ground engaging members 42 of the vehicle 14.

The first flange portion 148 is partially received within the first recess 128 of the first engaging portion 118. The second flange portion 150 is received within the second recess 138 of the second engaging portion 118. The first flange portion 148 has a first hole 154 and the second flange portion 150 has a second hole 156.

The push-roller assembly 116 further includes a first pin member 158 and a second pin member 160. The first pin member 158 is received through the first hole 154 of the first flange portion 148. The first pin member 158 is also partially received within both the first and second slots 130, 132. Further, the second pin member 160 is received through the second hole 156 of the second flange portion 150. The second pin member 160 is also partially received within the third and fourth slots 140, 142 of the second top plate 134 and the second bottom plate 136. Both the first pin member 158 and the second pin member 160 are movable between a plurality of positions along the longitudinal axis BB′ within the corresponding slots.

The push-roller assembly 116 also includes four first rollers 162 and four second rollers 164. The first rollers 162 are coupled with the first flange portion 148 of the push-roller support frame 144. The second rollers 164 are coupled with the second flange portion 150 of the second flange portion 150 of the push-roller support frame 144. The first rollers 162 are movable along with the first pin member 158 within the first recess 128. Further, the second rollers 164 are movable along with the second pin member 160 within the second recess 138 along the longitudinal axis BB′.

The push-roller assembly 116 includes an actuator 168 disposed on the frame 16 of the paving machine 10. The actuator 168 is adapted to selectively move the first pin member 158 and the second pin member 160 within the first recess 128 and the second recess 138, respectively, along the longitudinal axis BB′. The actuator 168 has a first end 170 coupled with the frame 16 and second ends 172 coupled with the first and second pin members 158, 160. The actuator 168 may be a hydraulic actuator, an electric actuator, a screw type actuator, a pneumatic actuator or any other linear actuator known in the art.

### INDUSTRIAL APPLICABILITY

The present disclosure relates to the push-roller assemblies 10, 116 for aligning and positioning the vehicle 14 with respect to the paving machine 10 during the paving operation. The first rollers 92, 162 and the second push-rollers 94, 164 of the push-roller assemblies 10, 116 engage with the rear set of ground engaging members 42 of the vehicle 14 when the vehicle 14 is backing towards the front end 26 of the paving machine 10. The push-roller support frames 76, 144 are movable along the longitudinal axes XX′, AA′ to position the first push-rollers 92, 162 and the second push-rollers 94, 164 at a predefined distance based on a size and configuration of the vehicle 10. Further, the actuators 100, 168 of the push-roller assemblies 10, 116 absorb impact loads caused by the vehicle 14, This prevents spillage of the paving material from the receptacle 20 of the paving machine 10 and marking or detects in the paving material during the paving operation.

The push-roller assemblies 10, 116 have simple and cost effective constructions without requiring a large number mechanical linkages and components. Further, the first push-rollers 92, 162 and the second push-rollers 94, 164 of the push-roller assemblies 10, 116 are adjusted by actuating the corresponding pin members, via the corresponding actuators 100, 168. Therefore a control of the actuators 100, 168 may be integrated with an operation of the paving machine 10, thereby simplifying the operation of the paving machine 10. Further, the push-roller assemblies 10, 116 may be conveniently retrofittable with an existing paving machine.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of what is disclosed. Such embodiments should be understood to fall within the scope of the present disclosure as determined based upon the claims and any equivalents thereof.

What is claimed is:

1. A paving machine comprising:
a frame having an engaging portion at a front end of the paving machine, the engaging portion includes a top plate, a bottom plate spaced apart from the top plate, a recess defined between the top plate and the bottom plate, and a slot formed within at least one of the top plate and the bottom plate; and
a push-roller assembly disposed at the front end of the paving machine, the push-roller assembly comprising:
a push-roller support frame coupled with the engaging portion, the push-roller support frame is adapted to move along a longitudinal axis of the paving machine, the push-roller support frame includes a supporting portion and a flange portion having a hole, wherein the flange portion is received substantially within the recess;
a pin member engageable to the flange portion through the hole of the flange portion and partially received within the slot of the engaging portion, the pin member is adapted to move between a plurality of positions along the longitudinal axis within the recess;
at least one roller coupled with the flange portion of the push-roller support frame, wherein the at least one roller is adapted to move within the recess along with the pin member during a movement of the push-roller support frame along the longitudinal axis;
an actuator disposed on the frame of the paving machine, the actuator having a first end coupled with the frame and a second end coupled with the pin member, wherein the actuator is adapted to selectively move the pin member within the recess; and
at least one push-roller coupled with the supporting portion, wherein the at least one push-roller is adapted to be engaged with a vehicle,
wherein the movement of the actuator causes the pin member and the at least one roller to displace the push-roller support frame with respect to the frame along the longitudinal axis.
